(19) United States
(12) Patent Application Publication
(10) Pub. No.: US 2004/0094684 A1
(43) Pub. Date: May 20, 2004

(54) Metal profile part and method of interconnecting metal profiles

(76) Inventor: Gottfried Sailer, Schorndorf (DE)

Correspondence Address: Mr. Robin W. Asher, Clark Hill P.L.C., Suite 3500, 500 Woodward Avenue, Detroit, MI, 48226-3435, US

(21) Appl. No.: 10/614,719

(22) Filed: Jul. 7, 2003

(30) Foreign Application Priority Data
Jul. 5, 2002 (DE) 10231121.8

(51) Int. Cl. F16M 13/00

(52) U.S. Cl. 248/424

(57) ABSTRACT

A metal profile part, comprising two or more superimposed metal profiles (12, 14), the metal profiles having openings/holes (22, 24) in the area of the superimposed contacting surfaces (16, 18) and the metal profiles being interconnected by means of injection molded plastic material (26) through the openings (22, 24). A method to interconnect metal profiles (12, 14) to create a metal profile part (10), the method comprising insertion of metal profiles (12, 14) to be interconnected in a tool in such a way that openings (22, 24) provided in contacting surfaces (16, 18) of the metal profiles (12, 14) are lying on top of each other in a generally congruent manner, and comprising injection molding of plastic material connections (26) in the area of the openings (22, 24) through the openings (22, 24) and subsequent curing of the plastic material connections (26).

### CROSS-REFERENCE TO RELATED APPLICATIONS

This applications claims priority of German Patent Application No. 102 31 121.8 filed on Jul. 5, 2002, entitled “Metallprofilteil und Verfahren zum Verbinden von Metallprofilen” which is incorporated herein by reference for all purposes.

### Microfiche Appendix

Not Applicable

### FIELD OF THE INVENTION

The present invention generally relates to the field of metal profile parts and a method of interconnecting metal profiles for making such metal profile parts. Such metal profile parts are particularly used in the automobile production.

### BACKGROUND OF THE INVENTION

Light weight components are known in the automobile production. In the prior art they were merely produced from one material, namely metal or plastics. For example, in the case of metal, a basic body deep-drawn from a steel sheet or aluminum sheet is welded, riveted, or bolted together with reinforcement ribs. In the case of plastics, light weight components were produced in one-piece by injection molding. There is a need to produce integrated components that are partially composed of metal and partially composed of plastics, because plastic material parts have lower strengths and most of all lower rigidities than metal parts at a fungible dimension of the cross sections. Such an integrated component is known from EP 0 370 342 B1. The known light weight component has a shell-shaped basic body whose interior is provided with reinforcement ribs that are firmly connected to the basic body. The reinforcement ribs are composed of a molded-on plastic material and their connection to the basic body is realized at discrete connection points by means of openings in the basic body through which the plastic material passes and extends over the surfaces of the openings.

A further method of making plastic material/metal integrated parts is known from EP 0 721 831 A1. In the method described therein, in a first step, individual sheets or sheet profiles that are to be connected are inserted in an injection molding tool and are interlockingly connected with each other by pressing or joining by means of a press die. Subsequently, the parts are connected with each other and connected to the formed plastic material part by molding-on a plastic material in the openings in the region of the joining or grouting point and/or in other superimposed openings of the individual sheets.

These integrated components, also called hybrid components, however, have the disadvantage of high material costs, since the employed plastic materials, particularly polyamide, are very expensive. Furthermore, they are subject to a comparatively high distortion since the plastic material portion deforms in the integrated component (so-called bimetal effect).

### SUMMARY OF THE INVENTION

In accordance with the invention, there is provided a metal profile part comprising two or more superimposed metal profiles, the metal profiles comprising openings in an area of superimposed contacting surfaces, said metal profiles being connected to each other by means of an injection molded plastic material through the openings.

In accordance with another aspect of the invention, there is provided, a method of connecting metal profiles to form a metal profile part comprising the steps of inserting the metal profiles to be connected with each other into a tool such that openings provided in respective contacting surfaces of the metal profiles are lying on top of each other in a substantially congruent manner; injection molding of plastic material connections in the area of the openings through the openings; and curing the plastic material connections.

In accordance with an embodiment of the present invention, the openings are generated after the metal profiles are inserted into the tool and aligned to each other with their respective contacting surfaces.

In accordance with the invention, a metal profile part is presented that comprises two superimposed metal profiles. The two superimposed metal profiles comprise openings in the area of the superimposed surfaces and are interconnected with each other by means of injecting plastic materials through these openings. Furthermore, a method of interconnecting metal profiles in accordance with the present invention is presented.

The present invention significantly reduces the distortion of the metal profile parts since the plastic material portion is significantly reduced. In addition, a higher strength and reliability of the metal profile connection is achieved than in conventional spot welding connections. The cost of the structural component in accordance with the invention can also be reduced by reducing the plastic material portion.

Further advantages and embodiments of the invention can be seen from the following detailed description and the enclosed drawings.

### BRIEF DESCRIPTION OF THE DRAWINGS

Exemplary embodiments of the invention will now be described in conjunction with the following drawings, wherein:

FIG. 1 shows the basic principle of the invention in accordance with a first embodiment by means of a schematic three-dimensional representation; and

FIG. 2 shows a perspective detailed representation of an automobile assembly carrier in accordance with a second embodiment of the invention.

### DETAILED DESCRIPTION OF THE PREFERRED EMBODIMENTS

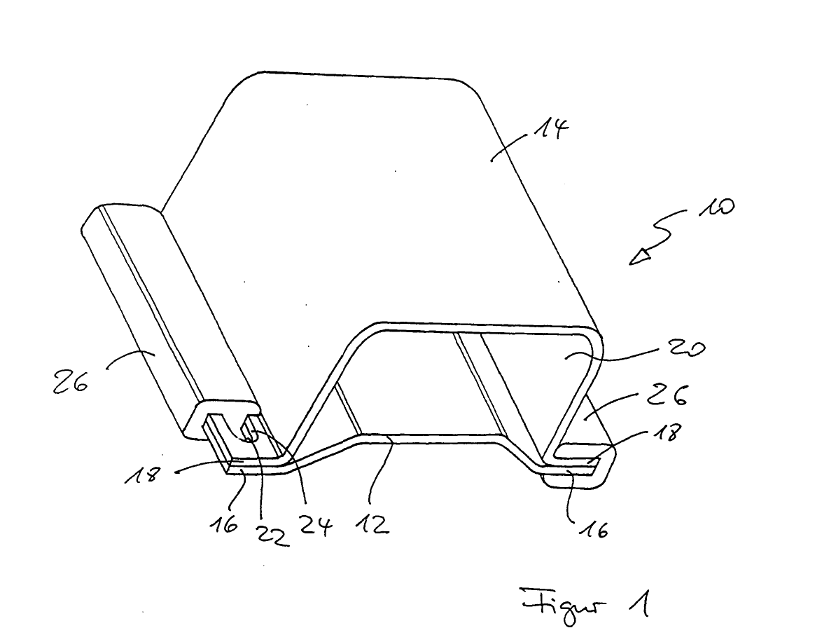

FIG. 1 shows a metal profile part 10 in accordance with the invention that comprises a first metal profile 12 and a second metal profile 14, the first and the second metal profile 12, 14 are connected with each other. The metal profiles 12 and 14 each have flat edge sections 16 and 18, respectively, which extend from both edges of the respective metal profile. The flat edge sections 16 and 18 of the metal profiles 12 and 14 form contacting surfaces between the metal profiles 12 and 14.

Both metal profiles 12, 14 are designed such that the edge sections 16, 18 are lying planar on top of each other when the metal profiles are superimposed. The second metal profile 14 of the embodiment of FIG. 1 is a deep drawn metal strap part and the first metal profile 12 is formed as a lid part to brace the metal strap part, wherein the lid part covers the recess 20 in the second metal profile 14.

Enclosed openings 22, 24, are provided in each of the edge sections 16 and 18 of the two metal profiles 12, 14, respectively. Preferably, openings 22, 24 are lying on top of each other in a congruent manner when the metal profiles are superimposed.

These openings 22, 24 serve for injecting the plastic material so that the metal profiles 12, 14 are connected with each other by means of plastic material parts 26. A plastic material suitable for injection molding is used for making the connection by means of injecting plastic materials. Preferably, the plastic material is a thermoplastic material.

The metal profiles that are to be connected are inserted in a tool, particularly an injection molding tool, to produce a metal profile part in accordance with the invention from two or more metal profiles or metal profile sheets. The position in the tool corresponds to the position in which the sheets are to be connected with each other. As mentioned heretofore, in this position, the openings in the edge sections of the sheets are lying in a planar and congruent manner on top each other.

In a next step, plastic material connections (plastic material parts 26) are molded-on by means of injection molding in the area of the openings 22, 24, and subsequently the plastic material connections are cured. After removal from the tool, the metal profiles to be connected with each other are interconnected with each other to form a metal profile part in accordance with the invention by means of plastic material injections.

In accordance with an advantageous embodiment of the invention, the openings in the edge sections of the sheets to be connected are produced after the sheets are inserted in the tool and the parts to be connected have been aligned with respect to each other. Proceeding in this manner ensures that the openings are aligned exactly on top of each other.

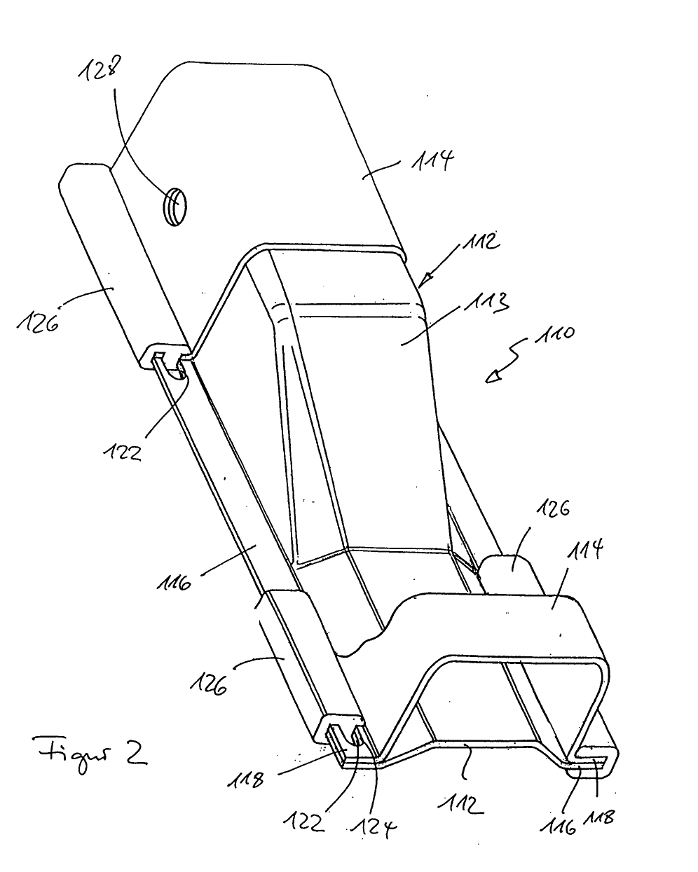

FIG. 2 shows an example from the area of automotive engineering as a further embodiment, namely a section of an assembly carrier, such as it is used, for example, during the assembly and installation of a front end module for the front end area of an automobile. The reference numerals for like parts are increased by 100 in the depiction of FIG. 2 as compared to FIG. 1.

The assembly carrier comprises a depicted metal profile 110 in accordance with the invention which consists of two metal profiles 112 and 114. Therein, the second metal profile 114 is designed as a U-profile and constitutes the actual assembly carrier, while the first metal profile 112 is designed as a cover profile to cover and brace the U-profile. The two metal profiles 112 and 114, as was already explained heretofore in conjunction with the depiction of FIG. 1, are connected to each other by means of plastic material injections 126 through the openings 122 or rather 124 in the edge sections (contacting surfaces) 116 or rather 118 of the metal profiles 112 and 114.

The first metal profile 112, which is designed as a cover profile, has a recess 113 as depicted in the back of FIG. 2 that protrudes into the U-profile of the second metal profile 114. This design is brought about by the form and function of the assembly carrier. This allows for example for an adding on the shell of an automobile and a bolting together by means of the congruently lying holes 128.

Thus, in accordance with the invention, a metal profile connection is provided whose torsion profile has a smaller distortion than in well-known hybrid/integrated components since less plastic material is used. On the other hand, the plastic material injection yields a higher fatigue strength than spot welding connections. Furthermore, the injection with plastic material provides the opportunity to provide for designs that facilitate an adding of assembly parts. Finally, the present metal profile connection is clearly more cost-effective than conventional hybrid components since, in accordance with the invention, the polyamide of the hybrid component is replaced by metal.

The above described embodiments of the invention are intended to be examples of the present invention and numerous modifications, variations, and adaptations may be made to the particular embodiments of the invention without departing from the spirit and scope of the invention, which is defined in the claims.

What is claimed is:

1. A metal profile part comprising two or more superimposed metal profiles, the metal profiles comprising openings in an area of superimposed contacting surfaces, said metal profiles being connected to each other by means of an injection molded plastic material through the openings.

2. A method of connecting metal profiles to form a metal profile part comprising the following steps:
inserting the metal profiles to be connected with each other into a tool such that openings provided in respective contacting surfaces of the metal profiles are lying on top of each other in a substantially congruent manner;
injection molding of plastic material connections in the area of the openings through the openings; and
curing the plastic material connections.

3. The method as defined in claim 2 wherein the openings are generated after the metal profiles are inserted into the tool and aligned to each other with their respective contacting surfaces.
